(19) United States
(12) Patent Application Publication
(10) Pub. No.: US 2017/0010490 A1
(43) Pub. Date: Jan. 12, 2017

(54) DISPLAY SUBSTRATE, DISPLAY PANEL AND DISPLAY DEVICE

(71) Applicants: BOE TECHNOLOGY GROUP CO., LTD., Beijing (CN); HEFEI XINSHENG OPTOELECTRONICS TECHNOLOGY CO., LTD., Hefei (CN)

(72) Inventors: Fangfang LI, Beijing (CN); Sangman YUK, Beijing (CN); Jongwon MOON, Beijing (CN); Chengyong ZHAN, Beijing (CN)

(21) Appl. No.: 15/081,345

(22) Filed: Mar. 25, 2016

(30) Foreign Application Priority Data
Jul. 8, 2015 (CN) 201510401938.9

(51) Int. Cl. G02F 1/1339

(52) U.S. Cl. CPC G02F 1/1339

(57) ABSTRACT

The present disclosure provides a display substrate, a display panel and a display device, belongs to the field of display technology, and can solve the problem of zara which is very likely to occur in an existing liquid crystal display panel. The display substrate of the present disclosure includes a display region and a peripheral region surrounding the display region, a sealant is provided on the peripheral region, and a side, close to and/or away from the display region, of the sealant on at least one side of the peripheral region is curved.

### FIELD OF THE INVENTION

The present disclosure relates to the field of display technology, and particularly to a display substrate, a display panel and a display device.

### BACKGROUND OF THE INVENTION

In recent years, liquid crystal displays are increasingly popular and have become the mainstream display devices in the market, due to their advantages such as low operating voltage, low power consumption, less radiation, small space occupancy, light weight, small thickness, artistic appearance, and the like. Currently, people's demand for the liquid crystal display, and particularly for the display quality of the entire display, is increasing continuously. Among others, the problem of zara is one of the critical factors that affect image display quality of the liquid crystal display.

A conventional liquid crystal panel includes two substrates and a liquid crystal layer sandwiched between the two substrates, and peripheral regions of the two substrates are provided with a sealant which seals the liquid crystal layer between the two substrates. If the sealant comes into contact with the liquid crystal layer prematurely and thus contaminates the liquid crystals in the liquid crystal layer, the phenomenon of zara will occur; during transport of the liquid crystal panel, the two substrates may be dislocated due to deformation of the sealant, as a result, post-spacers rub against the two substrates to damage the alignment film, and at this time, phenomenon of zara also occurs.

As shown in FIG. 1, a liquid crystal panel includes a display region Q1 and a peripheral region Q2, and generally, a sealant 200 only needs to be coated on the peripheral region Q2 of one of the substrates. In the process of coating, the sealant is generally coated along a straight line in the peripheral region of the substrate; that is, the coated sealant 200 generally appears as a rectangle on the substrate, as shown in FIG. 1. During transport, the upper and lower substrates of the liquid crystal panel may move relatively to each other, in this case, the long sides (on a first side 101 and a third side 103 of the substrate) of the sealant 200 will be subjected to a drawing force in the vertical direction and thus be deformed, and the short sides (on a second side 102 and a fourth side 104 of the substrate) thereof will be subjected to a drawing force in the horizontal direction and thus be deformed. The length L2 of the short sides determines fixing strength of the sealant 200 in the vertical direction, i.e., the deformation of the long sides of the sealant 200, and the length L1 of the long sides determines fixing strength of the sealant 200 in the horizontal direction, i.e., the deformation of the short sides of the sealant 200. In other words, the amount of deformation of the long sides of the sealant in the vertical direction depends on the length L2 of the short sides of the sealant; the amount of deformation of the short sides of the sealant in the horizontal direction depends on the length L1 of the long sides of the sealant. It can be seen that the amount of deformation of the long sides of the sealant 200 is larger than that of the short sides thereof. Therefore, during transport of the liquid crystal panel, the two substrates are dislocated due to the deformation of the sealant (especially, the deformation of the long sides thereof), thus post-spacers and the two substrates rub against each other to damage the alignment film, and the phenomenon of zara occurs. Hence, how to alleviate the above problem becomes a technical problem to be solved urgently.

### SUMMARY OF THE INVENTION

The technical problem to be solved by the present disclosure includes providing a display substrate, a display panel and a display device, which can effectively avoid occurrence of zara, in view of the above problem of the existing liquid crystal panel.

The technical solution adopted to solve the technical problem of the present disclosure is a display substrate, which includes a display region and a peripheral region surrounding the display region, a sealant is provided on the peripheral region, and a side, close to and/or away from the display region, of the sealant on at least one side of the peripheral region is curved.

Preferably, the display substrate is a quadrilateral, a first side and a third side of the display substrate are opposite and parallel to each other, a second side and a fourth side of the display substrate are opposite and parallel to each other, wherein length of the first side is larger than that of the second side, and the side, close to and/or away from the display region, of the sealant on each of the first and third sides of the display substrate is curved.

Preferably, the display substrate is a square, and the side, close to and/or away from the display region, of the sealant on each side of the display substrate is curved.

Preferably, for the sealant whose side close to and/or away from the display region is curved, the sides thereof close to and away from the display region are both curved.

Further preferably, the sealant, whose sides close to and away from the display region are both curved, is shaped like any one of a square wave, a triangle wave, and a sine wave.

Preferably, for the sealant whose side close to and/or away from the display region is curved, only the side thereof close to or away from the display region is curved.

Further preferably, for the sealant whose side close to or away from the display region is curved, the curved side is shaped like a square wave or a triangle wave.

Preferably, the display substrate is an array substrate or a color filter substrate.

The technical solution adopted to solve the technical problem of the present disclosure is a display panel, which includes the above display substrate.

The technical solution adopted to solve the technical problem of the present disclosure is a display device, which includes the above display panel.

The present disclosure has the following beneficial effects: a side, close to and/or away from the display region, of the sealant on at least one side of the display substrate of the present disclosure is designed to be curved, which is equivalent to add, to the sealant on the side, several components vertical to the extending direction thereof, so as to enhance adhesion of the sealant on the side onto the display substrate, avoid the deformation of the sealant on the side, and further avoid the occurrence of zara resulting from that relative movement between the display substrate and the opposite substrate thereof causes the post-spacers to rub against the two substrates and damage the alignment film during transport. The display panel and the display device of the present disclosure both include the above display substrate, and thus have better display effect.

### BRIEF DESCRIPTION OF THE DRAWINGS

FIG. 1 is a schematic plan of a substrate provided with sealant in a liquid crystal panel in the prior art;

FIG. 2 is a schematic plan of a display substrate in a first implementation of a first embodiment of the present application;

FIG. 3 is a schematic plan of another display substrate in the first implementation of the first embodiment of the present application;

FIG. 4 is a schematic plan of a display substrate in a second implementation of the first embodiment of the present application;

FIG. 5 is a schematic plan of a display substrate in a first implementation of a second embodiment of the present application; and

FIG. 6 is a schematic plan of a display substrate in a second implementation of the second embodiment of the present application.

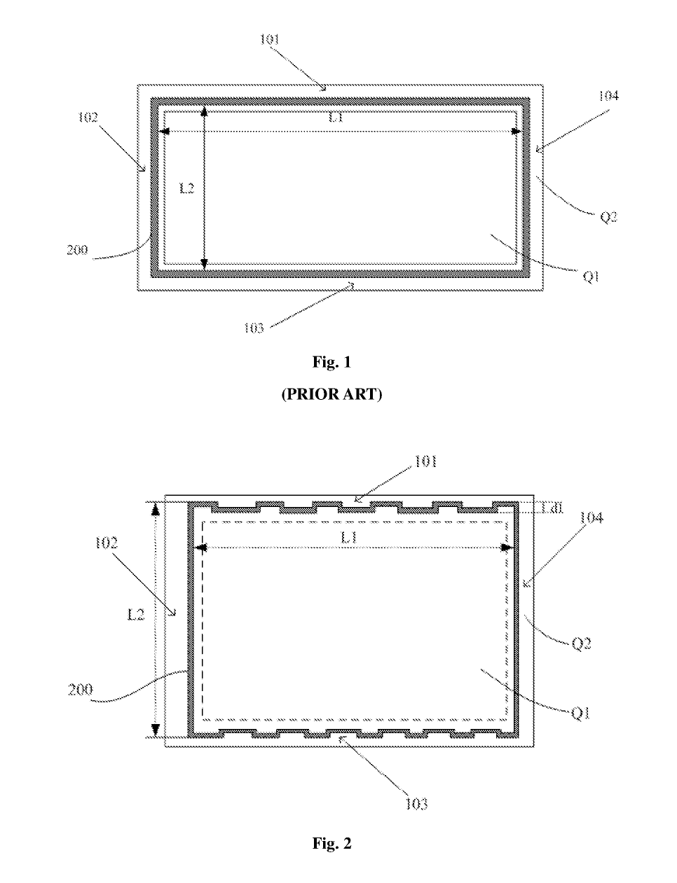

### DETAILED DESCRIPTION OF THE EMBODIMENTS

To enable those skilled in the art to better understand the technical solutions of the present disclosure, the present disclosure will be further described in detail below in conjunction with the accompanying drawings and the specific implementations.

A display substrate, including a display region and a peripheral region surrounding the display region, wherein, a sealant is provided on the peripheral region, and a side, close to and/or away from the display region, of the sealant on at least one side of the peripheral region is curved.

It should be noted that, the display substrate in the following embodiments may be an array substrate or a color filter substrate. The display substrate of the present disclosure will be described specifically in conjunction with the following embodiments.

### Embodiment 1

As shown in FIGS. 2 to 4, this embodiment provides a display substrate, which includes a display region Q1 and a peripheral region Q2 surrounding the display region Q1, and a sealant 200 is provided on the peripheral region Q2. The display substrate in this embodiment is a quadrilateral (for example, a rectangle), a first side 101 and a third side 103 of the display substrate are opposite and parallel to each other, a second side 102 and a fourth side 104 of the display substrate are opposite and parallel to each other; the length of the first side 101 is larger than that of the second side 102; sides, close to and/or away from the display region Q1, of the sealant 200 on the first side 101 and the third side 103 are curved.

It should be noted herein that, the first side 101 and the third side 103 of the display substrate respectively correspond to the upper side and the lower side of the display substrate shown in the figure, and accordingly, the second side 102 and the fourth side 104 respectively correspond to the left side and the right side.

The reason for designing the sides, close to and/or away from the display region Q1, of the sealant 200 on the first side 101 and the third side 103 of the display substrate to be curved is as follows. During transport, the display substrate and an opposite substrate thereof may move relatively to each other, so the sealant 200 on the first side 101 side and the third side 103 of the display substrate may be subjected to a drawing force in the vertical direction (i.e., upper-lower direction) and thus be deformed in the vertical direction; the sealant 200 on the second side 102 and the fourth side 104 of the display substrate may be subjected to a drawing force in the horizontal direction (i.e., left-right direction) and thus be deformed in the horizontal direction. The amount of deformation of the sealant 200 in the vertical direction depends on the length L2 of the sealant 200 in the vertical direction, and the larger length L2 of the sealant 200 in the vertical direction, the larger contact area between the sealant 200 and the display substrate in the vertical direction, and the smaller amount of deformation of the sealant 200 in the vertical direction. That is, the amount of deformation of the sealant 200 on the first side 101 and the third side 103 of the display substrate depends on the length L2 of the sealant 200 in the vertical direction, i.e., the length L2 of the sealant 200 on the second side 102 and the fourth side 104 of the display substrate, and specifically, the smaller length L2 of the sealant 200 on the second side 102 and the fourth side 104 of the display substrate, the larger amount of deformation generated in the sealant 200 on the first side 101 and the third side 103 of the display substrate. Similarly, the amount of deformation generated in the sealant 200 on the second side 102 and the fourth side 104 of the display substrate depends on the length L1 of the sealant 200 in the horizontal direction, i.e., the length L1 of the sealant 200 on the first side 101 and the third side 103 of the display substrate, and specifically, the smaller length L1 of the sealant 200 on the first side 101 and the third side 103 of the display substrate, the larger amount of deformation generated in the sealant 200 on the second side 102 and the fourth side 104. Since the length of the first side 101 of the display substrate is larger than that of the second side 102, i.e., the length L1 of the sealant 200 on the first side 101 and the third side 103 of the display substrate is larger than length L2 of the sealant 200 on the second side 102 and the fourth side 104, the sealant 200 on the first side 101 and the third side 103 of the display substrate is more likely to be deformed than the sealant 200 on the second side 102 and the fourth side 104 of the display substrate. Therefore, in this embodiment, the sides, close to and/or away from the display region Q1, of the sealant 200 on the first side 101 and the third side 103 of the display substrate are designed to be curved, in order to alleviate the deformation of the sealant 200 on the first side 101 and the third side 103 of the display substrate.

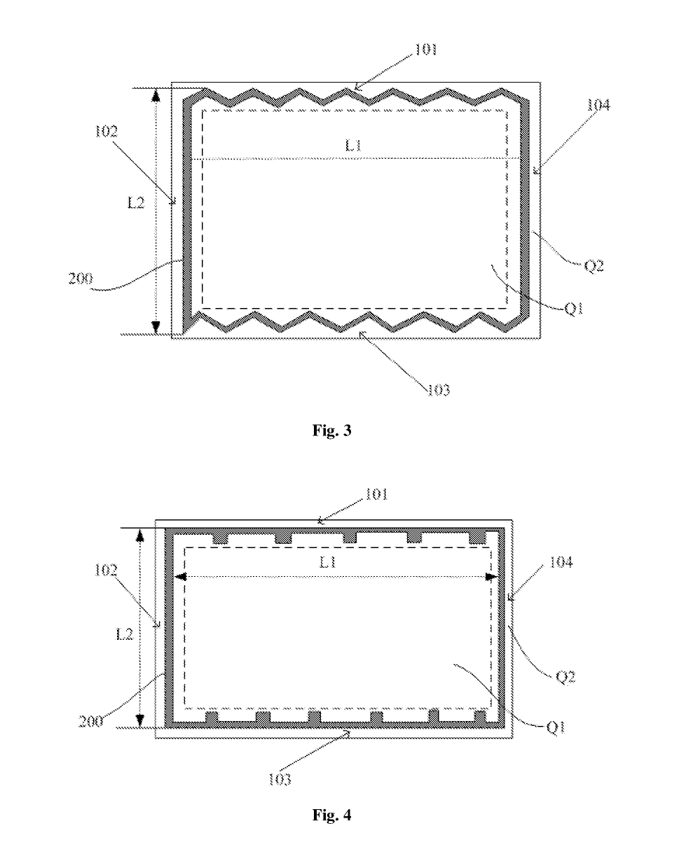

Specifically, as a first implementation of the embodiment, both sides, close to and away from the display region Q1, of the sealant 200 on the first side 101 and the third side 103 of the display substrate are designed to be curved. In this case, the sealant 200 on the first side 101 and the third side 103 of the display substrate may be shaped like any one of a square wave (FIG. 2), a triangle wave (FIG. 3), and a sine wave, or may be of other shape.

As shown in FIG. 2, description is given by taking the case where the sealant 200 on the first side 101 and the third side 103 of the display substrate is shaped like a square wave as an example. In the case shown in FIG. 2, the sealant 200 on each of the first side 101 and the third side 103 of the display substrate includes a plurality of horizontal components and a plurality of vertical components d1. In this way, during transport, deformation in vertical direction generated in the sealant 200 on the first side 101 and the third side 103 of the display substrate appears at positions of the plurality of horizontal components. Since the sealant 200 on the first side 101 and the third side 103 of the display substrate further includes the plurality of vertical components d1, which increase the contact area between the sealant 200 and the display substrate in the vertical direction, enhance adhesion of sealant 200 on the first side 101 and the third side 103 of the display substrate onto the display substrate in the vertical direction, thus reduce the amount of deformation, in the vertical direction, of the plurality of the horizontal components of the sealant 200 on the first side 101 and the third side 103 of the display substrate, and further avoid the occurrence of zara resulting from that large amount of deformation of the sealant 200, i.e., large relative displacement between the display substrate and the opposite substrate thereof, causes the nearby post-spacers to rub against the alignment film and damage the same during transport.

Specifically, the number and the lengths of the vertical components dl of the sealant 200 may be adjusted to regulate the amount of deformation of the sealant 200 on the first side 101 and the third side 103 of the display substrate. It also needs to be noted that, the lengths of the vertical components dl of the sealant 200 are limited by the size of the display substrate itself, and need to be smaller than the distance from the edge of the display region Q1 to the sealant 200 so as to avoid affecting the display effect of the display region Q1.

As shown in FIG. 3, the sealant 200 on the first side 101 and the third side 103 of the display substrate is shaped like a triangle wave, and in this case, each segment of the triangle wave can be decomposed into a horizontal component and a vertical component d1. Therefore, compared with the sealant 200 coated in a straight line in the prior art, the vertical components d1 of the sealant 200 are also added, and the vertical components d1 increase the contact area between the sealant 200 and the display substrate in the vertical direction, enhance adhesion of sealant 200 on the first side 101 and the third side 103 of the display substrate onto the display substrate in the vertical direction, thus reduce the amount of deformation, in the vertical direction, of the sealant 200 on the first side 101 and the third side 103 of the display substrate, and further avoid the occurrence of zara resulting from that large amount of deformation of the sealant 200, i.e., large relative displacement between the display substrate and the opposite substrate thereof, causes the nearby post-spacers to rub against the alignment film and damage the same during transport. The working principle of the sealant 200 shaped like a sine wave or the like is the same as that described above, and will not be elaborated here.

As a second implementation of the embodiment, the side, close to or away from the display region Q1, of the sealant 200 on each of the first side 101 and the third side 103 of the display substrate is a curve. Specifically, the curve may be shaped like a square wave or a triangle wave. The following description is given by taking the case where the side, close to the display region Q1, of the sealant 200 on each of the first side 101 and the third side 103 of the display substrate is a curve as an example.

As shown in FIG. 4, the side, close to the display region Q1, of the sealant 200 on each of the first side 101 and the third side 103 of the display substrate is a curve, which is equivalent to that the pattern of the existing sealant 200 is provided with a plurality of protrusions facing the display region Q1 of the display substrate, and the protrusions may be rectangular, triangular, or the like. These protrusions add the vertical components of the sealant 200, i.e., increase the contact area between the sealant 200 and the display substrate in the vertical direction, enhance adhesion of sealant 200 on the first side 101 and the third side 103 of the display substrate onto the display substrate in the vertical direction, thus reduce the amount of deformation, in the vertical direction, of the horizontal components of the sealant 200 on the first side 101 and the third side 103 of the display substrate, and further avoid the occurrence of zara resulting from that large amount of deformation of the sealant 200, i.e., large relative displacement between the display substrate and the opposite substrate thereof, causes the nearby post-spacers to rub against the alignment film and damage the same during transport.

In the second implementation of the embodiment, it may also be the side, away from the display region Q1, of the sealant 200 on each of the first side 101 and the third side 103 of the display substrate that is a curve, that is, the side, away from the display region Q1, of the sealant 200 on each of the first side 101 and the third side 103 of the display substrate is provided with a plurality of protrusions, and the principle of reducing the amount of deformation of the sealant 200 is the same as that described above, and will not be elaborated here.

Similarly, in this implementation, the number and the heights of the protrusions may be adjusted to regulate the amount of deformation of the sealant 200 on the first side 101 and the third side 103 of the display substrate. It also needs to be noted that, the heights of the protrusions on the sealant 200 are limited by the size of the display substrate itself, and need to be smaller than the distance from the edge of the display region Q1 to the sealant 200 so as to avoid affecting the display effect of the display region Q1 when the protrusions are provided on the side, close to the display region Q1, of the sealant 200 on each of the first side 101 and the third side 103 of the display substrate.

Needless to say, in the above two implementations, it is also possible to design the sealant 200 on the second side 102 and the fourth side 104 of the display substrate to be curve-shaped at the same time, so as to alleviate the deformation of the sealant 200 on the second side 102 and the fourth side 104 of the display substrate. The principle thereof is the same as that described above, and will not be described repeatedly here.

### Embodiment 2

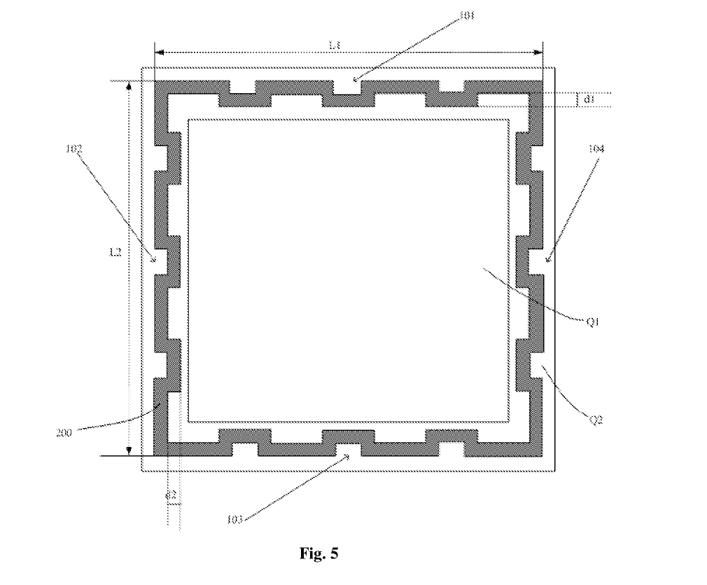

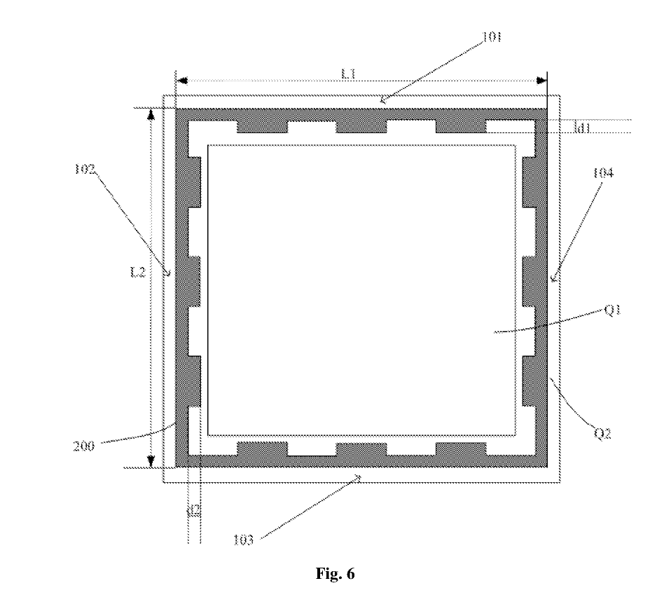

As shown in FIGS. 5 and 6, this embodiment provides a display substrate, which includes a display region Q1 and a peripheral region Q2 surrounding the display region Q1, and a sealant 200 is provided on the peripheral region Q2. Unlike Embodiment 1, the display substrate in this embodiment is a square, that is, the lengths of the four sides are the same, and therefore, a side, close to and/or away from the display region Q1, of the sealant 200 in the peripheral region Q2 of the display substrate (i.e., on each of four sides of the display substrate) is designed to be a curve.

The reason for such design is that, during transport, the display substrate and the substrate opposite thereto move relatively to each other, and the sealant 200 on each of the four sides of the display substrate has the same length, is subjected to substantially the same drawing force, and thus has roughly the same amount of deformation. Therefore, the sealant 200 on each of the four sides of the display substrate is improved.

As a first implementation of the embodiment, as shown in FIG. 5, the sides, close to and away from the display region Q1, of the sealant 200 on the each side of the display substrate are designed to be curved, and specifically, the sealant 200 on each side of the display substrate may be shaped like a square wave. Like the principle described in Embodiment 1, in this case, it is equivalent to that the vertical components dl of the sealant 200 on the first side 101 and the third side 103 of the display substrate are added to enhance adhesion of sealant 200 on the first side 101 and the third side 103 of the display substrate onto the display substrate in the vertical direction of the display substrate, and thus reduce the amount of deformation, in the vertical direction, of the horizontal components of the sealant 200 on the first side 101 and the third side 103 of the display substrate; similarly, it is equivalent to that the horizontal components d2 of the sealant 200 on the second side 102 and the fourth side 104 of the display substrate are added to enhance adhesion of sealant 200 on the second side 102 and the fourth side 104 of the display substrate onto the display substrate in the horizontal direction of the display substrate, and thus reduce the amount of deformation, in the horizontal direction, of the vertical components of the sealant 200 on the second side 102 and the fourth side 104 of the display substrate. In this way, the deformation of the entire sealant 200 is reduced, and the occurrence of zara, resulting from that large amount of deformation of the sealant 200, i.e., large relative displacement between the display substrate and the opposite substrate thereof, causes the nearby post-spacers to rub against the alignment film and damage the same during transport, is avoided.

Like Embodiment 1, the sealant 200 on each side of the display substrate in this embodiment may be shaped like a triangle wave or a sine wave.

As a second implementation of the embodiment, as shown in FIG. 6, a side, close to or away from the display region Q1, of the sealant 200 on each side of the display substrate is a curve. Specifically, the curve may be shaped like a square wave or a triangle wave. In this case, like Embodiment 1, it is equivalent to that the sealant 200 on each side of the display substrate is provided with a plurality of protrusions, and the protrusions may face the display region Q1 or face away from the display region Q1. The protrusions may be rectangular, triangular, or the like. In this case, the protrusions on the first side 101 and the third side 103 of the display substrate add the vertical components of the sealant 200, i.e., increase the contact area between the sealant 200 and the display substrate in the vertical direction, enhance adhesion of sealant 200 on the first side 101 and the third side 103 of the display substrate onto the display substrate in the vertical direction of the display substrate, and thus reduce the amount of deformation, in the vertical direction, of the horizontal components of the sealant 200 on the first side 101 and the third side 103 of the display substrate; similarly, the protrusions on the second side 102 and the fourth side 104 of the display substrate add the horizontal components d2 of the sealant 200, thus reduce the amount of deformation, in the horizontal direction, of the vertical components of the sealant 200 on the second side 102 and the fourth side 104 of the display substrate, and further avoid the occurrence of zara resulting from that large amount of deformation of the sealant 200, i.e., large relative displacement between the display substrate and the opposite substrate thereof, causes the nearby post-spacers to rub against the alignment film and damage the same during transport.

### Embodiment 3

This embodiment provides a display panel and a display device, the display panel includes the display substrate described in Embodiment 1 or 2, and the display device includes the display panel. As the display panel includes the above-described display substrate, it has good quality, and the phenomenon of zara is less likely to occur.

The display device may be any product or component with a display function, such as a mobile phone, a tablet computer, a television, a display, a notebook computer, a digital photo frame, a navigator or the like.

Needless to say, the display device of the embodiment may also include other conventional structures, such as a power supply unit, a display driving unit, and the like, which are not elaborated here.

It can be understood that, the above implementations are merely exemplary implementations used for explaining the principle of the present disclosure, but the present disclosure is not limited thereto. For those skilled in the art, various modifications and improvements may be made without departing from the spirit and essence of the present disclosure, and these modifications and improvements are also deemed as falling within the protection scope of the present disclosure.

1. A display substrate, comprising a display region and a peripheral region surrounding the display region, wherein, a sealant is provided on the peripheral region, and a side, close to and/or away from the display region, of the sealant on at least one side of the peripheral region is curved.

2. The display substrate according to claim 1, wherein, the display substrate is a quadrilateral, a first side and a third side of the display substrate are opposite and parallel to each other, a second side and a fourth side of the display substrate are opposite and parallel to each other; length of the first side is larger than that of the second side; the side, close to and/or away from the display region, of the sealant on each of the first and third sides of the display substrate is curved.

3. The display substrate according to claim 1, wherein, the display substrate is a square, and the side, close to and/or away from the display region, of the sealant on each side of the display substrate is curved.

4. The display substrate according to claim 1, wherein, for the sealant whose side close to and/or away from the display region is curved, the sides thereof close to and away from the display region are both curved.

5. The display substrate according to claim 4, wherein, the sealant, whose sides close to and away from the display region are both curved, is shaped like any one of a square wave, a triangle wave, and a sine wave.

6. The display substrate according to claim 1, wherein, for the sealant whose side close to and/or away from the display region is curved, only the side thereof close to or away from the display region is curved.

7. The display substrate according to claim 6, wherein, for the sealant whose side close to or away from the display region is curved, the curved side is shaped like a square wave or a triangle wave.

8. The display substrate according to claim 1, wherein, the display substrate is an array substrate or a color filter substrate.

9. A display panel, comprising the display substrate according to claim 1.

10. The display panel according to claim 9, wherein, the display substrate is a quadrilateral, a first side and a third side of the display substrate are opposite and parallel to each other, a second side and a fourth side of the display substrate are opposite and parallel to each other; length of the first side is larger than that of the second side; the side, close to and/or away from the display region, of the sealant on each of the first and third sides of the display substrate is curved.

11. The display panel according to claim 9, wherein, the display substrate is a square, and the side, close to and/or away from the display region, of the sealant on each side of the display substrate is curved.

12. The display panel according to claim 9, wherein, for the sealant whose side close to and/or away from the display region is curved, the sides thereof close to and away from the display region are both curved.

13. The display panel according to claim 12, wherein, the sealant, whose sides close to and away from the display region are both curved, is shaped like any one of a square wave, a triangle wave, and a sine wave.

14. The display panel according to claim 9, wherein, for the sealant whose side close to and/or away from the display region is curved, only the side thereof close to or away from the display region is curved.

15. The display panel according to claim 14, wherein, for the sealant whose side close to or away from the display region is curved, the curved side is shaped like a square wave or a triangle wave.

16. The display panel according to claim 9, wherein, the display substrate is an array substrate or a color filter substrate.

17. A display device, comprising the display panel according to claim 9.
